(19) United States
(12) Patent Application Publication
(10) Pub. No.: US 2021/0325239 A1
(43) Pub. Date: Oct. 21, 2021

(54) Systems and Methods for Testing Operation of Ultrasonic Cleaning Machines

(71) Applicant: Propper Manufacturing Co., Inc., Long Island City, NY (US)

(72) Inventor: Andrew Sharavara, Bronx, NY (US)

(21) Appl. No.: 16/854,203

(22) Filed: Apr. 21, 2020

(51) Int. Cl. G01H 17/00; B08B 3/12; B06B 1/02

(52) U.S. Cl. CPC G01H 17/00; B08B 3/12; B06B 2201/71; B06B 2201/40; B06B 1/02

(57) ABSTRACT

A system and method that enables a reliable and consistent testing of ultrasonic cleaning machines comprising of a test sheet preferably used with a frame support. The device and method can be used for verification of performance of ultrasonic cleaning equipment, including detection of non-functioning ultrasonic transducers.

### FIELD OF THE INVENTION

This invention relates to a systems and methods for testing operation of an ultrasonic cleaning machine, and in particular to systems and methods for detecting whether ultrasonic transducers in ultrasonic cleaning machines are operational.

### BACKGROUND

Ultrasonic cleaning machines are widely used in medical, aerospace and other industries. In typical applications, contaminated medical or laboratory instruments in healthcare, or parts, components or finished devices in industrial manufacturing processes with residues are placed in a tank of water which is exposed to ultrasonic energy. The exposure creates cavitation which has a strong cleaning effect and removes impurities or biological contamination from surfaces of objects being cleaned. Depending on the type of contamination and materials, ultrasonic cleaning machines use different frequencies, typically in the range from 40 kHz (mostly used to remove blood and other biological materials) to 270 kHz. Higher frequencies are used in industrial applications to remove particles and impurities derived from the manufacturing process. An example of a commercially available ultrasonic cleaning machine is the Ultra 2000 (Ultrasonic LLC, Cincinnati, Ohio, USA).

Most of the ultrasonic cleaning machines currently present on the market have 2-16 transducers that generate ultrasonic energy. The transducers are located beneath the water tank bottom and typically cannot be visually located on the tank bottom surface.

The ultrasonic transducers may malfunction or break down as a result of natural deterioration, problems with electronic circuits, wiring and other components. Such malfunction reduces efficiency of the cleaning process. Also, the efficiency of the ultrasonic cleaning process may be reduced by the tank being overloaded with objects to be cleaned, or by use of incorrect machine settings or other types of user error. Thus, it may be difficult to distinguish if the reduced efficiency results from transducer malfunction or human error. Evaluation of each transducer of the underperforming ultrasonic machine by professional technical personnel is time-consuming, very expensive and the evaluation may need to be performed at the manufacturer's facility.

In case of suspected decline in machine cleaning effectiveness, a costly service call needs to be made and diagnostic procedures requiring disassembly of the machine to access electronic components need to be performed. There is also no reliable method for installation and operational testing of a new machine at the user's site.

Currently, there are no simple and reliable methods to detect if an individual ultrasonic transducer in an ultrasonic bath is functional. There are also no methods for distinguishing degradation of the machine performance from user errors.

One known standard method of testing the efficacy of ultrasonic cleaning devices is the foil cavitation test which involves immersion of a thin sheet of aluminum foil in an ultrasonic machine tank (HTM-01-05). The cavitation process results in erosion of the surface and appearance of small holes in the aluminum. However, the aluminum foil test is designed to detect presence of the ultrasonic cavitation in general. The erosion on the aluminum sheet surface is inconsistent and it does not show “hot spots” where the transducers are located, and does not indicate whether each transducer works. Also, it is difficult to handle thin aluminum sheets, and after testing the aluminum foil is not suitable for record-keeping.

A second known method as disclosed in U.S. Pat. No. 5,660,909 involves a complex system of a fluid with an extremely high number of bubbles consisting of a minute quantity of gas covered with an extremely thin coating with the bubbles dispersed and sealed in a bag-like transparent structure. The method is intended for transducers positioned inside a tank which is not a typical configuration for commercially available ultrasonic cleaning machines. A disadvantage of the method is that the bag has a very limited dimension and thus the bag cannot cover the entire surface of a tank to detect working transducers. Besides that, the method is highly complex and not practical, and does not allow for record-keeping of the results.

A third category of known methods involves placement of various electronic sensors in an ultrasonic machine tank. The sensors detect cavitation in a small area around their location and do not indicate overall performance of the ultrasonic machine. Further, the sensors do not show location of transducers and do not demonstrate if the transducers work. The method is very expensive and cannot be used in routine verification processes.

A fourth category of known methods involves the use of chemical monitors in vials (as disclosed in U.S. Pat. No. 7,708,836) or on a carrier that change color after exposure to an ultrasonic process. The indicators are typically small, with a detection area about ½ sq. inch for strips, and less than 1-inch in length for the vials. The indicators respond only to the cavitation in the area of their location, and do not represent the process in the ultrasonic machine and do not indicate individual transducer performance.

In general, none of the existing methods allows for verification of performance of the entire ultrasonic machine and for detection of individual non-functioning or deteriorating transducers. Accordingly, there is a need for a device and method that enables simple and reliable testing of an entire ultrasonic machine with detection of individual broken transducers, while allowing for convenient record keeping.

### SUMMARY OF THE INVENTION

An object of the present invention is to provide a system and method for testing the performance of an ultrasonic cleaning machine that addresses the above-mentioned issues existing in the conventional art.

Another object of the present invention is to provide a system and method for testing whether a malfunction of an ultrasonic cleaning machine results from user error or from a specific malfunction of individual component parts, such as individual ultrasonic transducers of the machine.

Systems and methods according to exemplary embodiment of the present invention involve the use of a test-sheet for measuring an ultrasonic cavitation process, where the test sheet is made up of a non-soluble substrate material coated with cavitation-sensitive indicator ink. The test sheet may have various dimensions corresponding to various tank sizes. The test sheet may be positioned close to the tank bottom. In exemplary embodiments, the test sheet may be placed in a frame to hold the sheet in place.

A method of testing operation of an ultrasonic cleaning machine according to an exemplary embodiment of the present invention comprises: providing a test sheet comprising a substrate and an ink composition disposed on the substrate; disposing the test sheet within the ultrasonic cleaning machine so that the test sheet is positioned in facing relation to ultrasonic transducers of the ultrasonic cleaning machine; and operating the ultrasonic cleaning machine so that visually discernable regions are formed at locations on the test sheet that correspond to operational ones of the ultrasonic transducers.

According to an exemplary embodiment, a color of the ink composition is different from a color of the substrate.

According to an exemplary embodiment, the visually discernable regions result from at least partial removal of the ink composition from the substrate.

According to an exemplary embodiment, the ink composition is blue and the substrate is white.

According to an exemplary embodiment, the visually discernable regions result from degradation of the ink composition.

According to an exemplary embodiment, the visually discernable regions result from change of color of the ink composition.

According to an exemplary embodiment, the ultrasonic cleaning machine is operated for a time of 3 seconds to 20 minutes.

According to an exemplary embodiment, the ink composition is water insoluble.

According to an exemplary embodiment, the test sheet is disposed within the ultrasonic cleaning machine at a location spaced at a distance from a bottom of a tank of the ultrasonic cleaning machine.

According to an exemplary embodiment, the distance is 1/16 inch to 2 inches.

According to an exemplary embodiment, the test sheet is sized so as to be in direct facing relation to all transducers of the ultrasonic cleaning machine.

According to an exemplary embodiment, the substrate is made of plastic, synthetic paper, glass or metal.

According to an exemplary embodiment, the substrate is made of flashspun high-density polyethylene fibers.

According to an exemplary embodiment, the ink composition comprises at least one of proteins, lipids, polysaccharides or combinations thereof, and stabilizers.

According to an exemplary embodiment, the ink composition comprises at least one of graphite, metal, oils or combinations thereof, and stabilizers.

According to an exemplary embodiment, the step of disposing comprises placing the test sheet below a basket of the ultrasonic cleaning machine.

According to an exemplary embodiment, the step of disposing comprises placing the test sheet within a frame and disposing the frame within the ultrasonic cleaning machine.

According to an exemplary embodiment, the frame is adjustable in at least one of size or shape.

According to an exemplary embodiment, the frame comprises fastening components that hold the test sheet in the frame.

According to an exemplary embodiment, the fastening components comprise pins, clips or adhesive.

A system according to an exemplary embodiment of the present invention for testing operation of an ultrasonic cleaning machine comprises: a test sheet comprising: a substrate; and an ink composition disposed on the substrate, the test sheet being configured for placement in the ultrasonic cleaning machine in facing relation to ultrasonic transducers of the ultrasonic cleaning machine so that operating the ultrasonic cleaning machine results in formation of visually discernable regions at locations on the test sheet that correspond to operational ones of the ultrasonic transducers.

Various embodiments of the invention are described in further detail in the following sections as well as in the drawings.

### BRIEF DESCRIPTION OF THE DRAWINGS

Exemplary embodiments of the present invention will be described with reference to the accompanying figures, wherein:

FIG. 1. shows a test sheet according to an exemplary embodiment of the present invention before ultrasonic exposure;

FIG. 2. is a representational illustration of a test sheet according to an exemplary embodiment of the present invention after ultrasonic exposure in an ultrasonic cleaning machine indicating that all twelve transducers within the machine are operational;

FIG. 3. is a photograph of a sample of a test sheet according to an exemplary embodiment of the present invention after 1.5 min exposure to 270 kHz of ultrasonic energy within a large volume bath of an ultrasonic cleaning machine;

FIG. 4. is a representational illustration of a test sheet according to an exemplary embodiment of the present invention after ultrasonic exposure indicating that one transducer (transducer no. 7) is not operational;

FIG. 5. is a representational illustration of a test sheet according to an exemplary embodiment of the present invention after ultrasonic exposure indicating that one transducer (transducer no. 6) has reduced output;

FIG. 6A. is a photograph of a test sheet according to an exemplary embodiment of the present invention prior to ultrasonic exposure;

FIG. 6B is a photograph of the test sheet shown in FIG. 6A after 0.5 min exposure to 40 kHz of acoustic energy in a small volume bath of an ultrasonic cleaning machine showing operational transducers;

FIG. 7. shows a test sheet positioned within an ultrasonic bath tank in accordance with an exemplary embodiment of the present invention;

FIG. 8. shows a test sheet positioned under a basket within an ultrasonic bath tank in accordance with an exemplary embodiment of the present invention;

FIG. 9. is an illustration of a frame holder for a test sheet according to an exemplary embodiment of the present invention; and

FIG. 10 is an illustration of an expandable holder frame according to an exemplary embodiment of the present invention.

### DETAILED DESCRIPTION

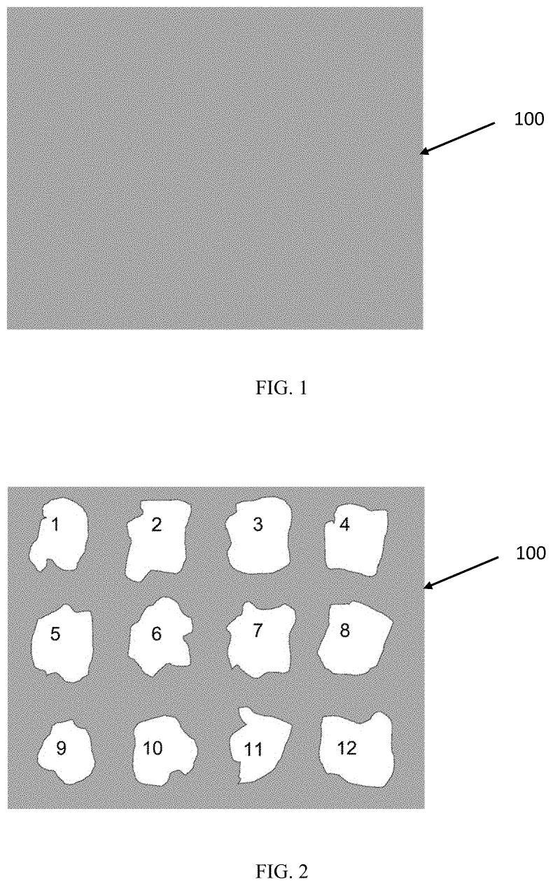

FIG. 1 shows an ultrasonic test sheet, generally designated by reference number 100, according to an exemplary embodiment of the present invention 1. The sheet 100 is made up of a substrate coated with a chemical indicator ink. Both the substrate and the indicator ink are preferably water insoluble. The indicator ink may cover the substrate completely or partially. The indicator ink color can be any color that is visually discernable from the color of the substrate. For example, the indicator ink may be blue and the substrate may be white. Although the ultrasonic test sheet 100 is shown having a rectangular shape, it should be appreciated that the sheet 100 may have any other shape, such as, for example, square, oval, or circular. In an exemplary embodiment, the indicator ink composition simulates a typical contamination with impurities of instruments or parts to be cleaned within an ultrasonic cleaning process.

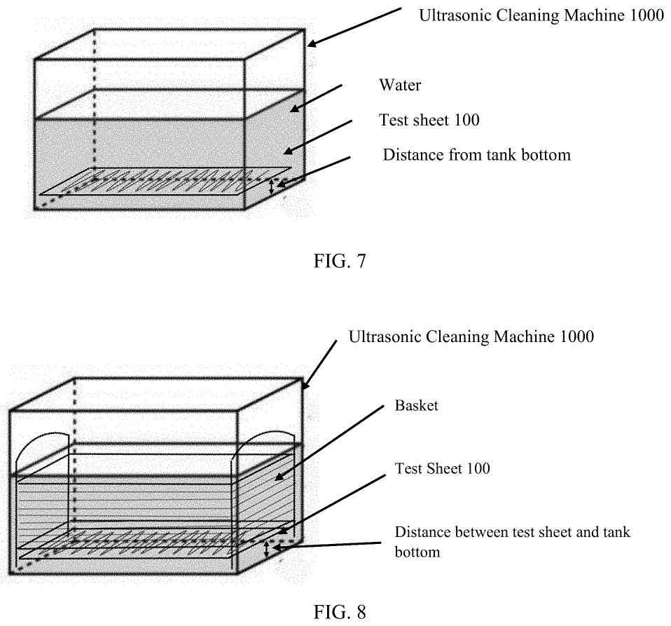

In use, the test sheet 100 is positioned inside an ultrasonic cleaning machine 1000 at a position close to the ultrasonic transducers of the machine, for example close to the machine bottom as shown in FIG. 7. Upon exposure to the cavitation produced by the ultrasonic machine transducers, the indicator test sheet in the areas of location of individual transducers will change in color due to at least partial removal of the indicator ink within those areas. In this regard, the test sheet 100 is preferably positioned at a distance from the machine bottom (or at a distance from some other internal surface of the machine at which the transducers are located) to allow for the cavitation to propagate through the liquid before exposure to the sheet 100.

In exemplary embodiments, if the substrate is white and the indicator is blue, the area where the indicator is removed during the processing will be white. The surrounding background will remain blue. Upon exposure to cavitation the ink bond to the substrate physically degrades and the ink is removed from the substrate in the proximity of the transducers. For example, FIG. 12 shows the test sheet 100 after processing with a pattern of twelve regions or spots in which the indicator ink has been removed at locations corresponding to twelve operating ultrasonic transducers. It should be appreciated that the color combinations of the indicator ink and substrate are not limited to those mentioned herein, and any other color combinations that provide visually discernable areas on the test sheet are encompassed by the present invention.

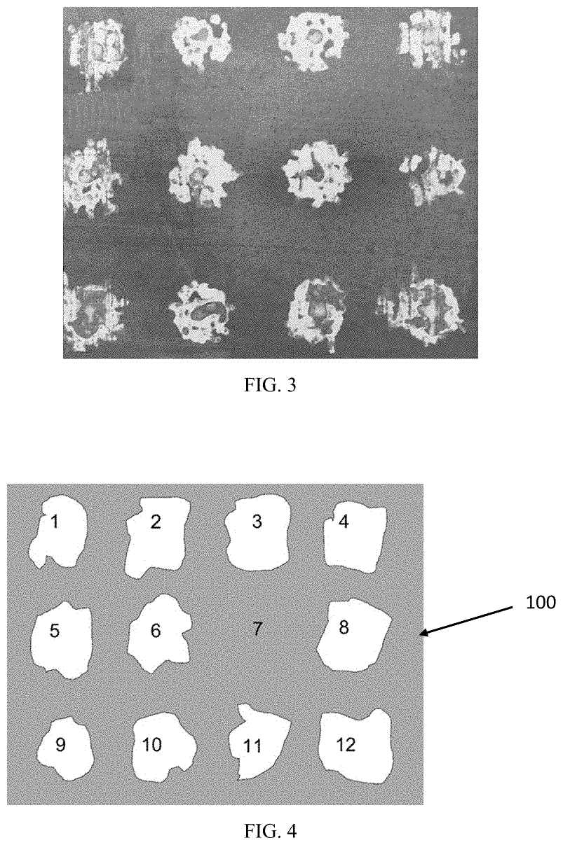

FIG. 3. is a photograph of a test sheet sample according to an exemplary embodiment of the present invention after processing in an ultrasonic cleaning machine indicating that all transducers are operational. If the transducer design has a center core that does not emit ultrasonic waves, the resulting pattern on the test sheet will be made up of ring-shaped regions with central portions in which the indicator ink has not been removed or only partially removed.

FIG. 4. is an illustration of the test sheet 100 after processing in an ultrasonic cleaning machine indicating that one of the transducers (transducer no. 7) is not functioning properly. In this case, the location on the test sheet 100 in proximity to the broken transducer remains coated with the indicator ink, and therefore the color at that location has not been changed.

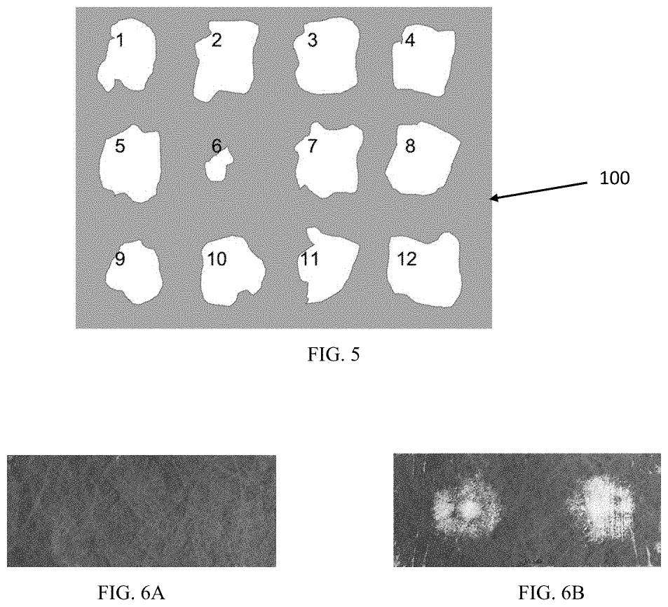

FIG. 5. is an illustration of the test sheet 100 indicating that one of the transducers (transducer no. 6) has a reduced output level.

FIGS. 6A and 6B show a test sheet according to an exemplary embodiment of the present invention before processing and after processing, respectively, indicating fully operational transducers of a smaller size ultrasonic machine with two transducers.

In exemplary embodiments, the size of the spots with color change may be different depending on the transducer frequency, distance of the test sheet from the bottom, temperature and physical and chemical characteristics of the substrate and ink. If a transducer does not work, or has reduced power, location of that transducer and its ultrasonic efficiency can be easily determined on the test sheet based on the color of the sheet remaining unaltered at a location directly above the transducer. If the transducer has reduced power, the size of the spot and degree of color change will be different compared to the other spots on the test sheet. For example, the spot corresponding to an impaired transducer may be reduced in size and/or the spot color may appear closer to that of the indicator ink as compared to other spots corresponding to transducers that are fully operational.

The indicator ink can be any chemical mixture that is sensitive to the cavitation and insoluble in water. In exemplary embodiments, the indicator ink may degrade upon exposure to cavitation with such degradation resulting in the ink changing color or in at least partial removal of the ink composition from the underlying substrate. In exemplary embodiments, the test sheet may include layers of ink compositions, with each layer of ink composition differing in color, so that the intensity of cavitation produced by individual transducers can be determined based on the resulting color at the corresponding spots on the test sheet. For example, if the test sheet includes a top ink composition that is blue and a red ink composition below the top ink composition, areas on the test sheet that represent fully functional transducers may be appear entirely or substantially red (or entirely or substantially the color of the underlying substrate) while areas on the test sheet that represent malfunctioning transducers may appear entirely or substantially blue.

In an exemplary embodiment, the indicator ink is a mixture of organic chemicals such as, for example, proteins, polysaccharides, and/or lipids, along with coloring agents and stabilizers. This type of the ink formulation mimics organic contamination and can be removed from the test sheet by cavitation in ultrasonic machines with the parameters used by healthcare facilities and biomedical and scientific labs. In this embodiment the color of the ink is visually different compared to the color of the substrate to clearly visualize the test results. This allows for clear distinctions between the substrate color above the transducers where the ink is removed, and surrounding areas still covered by the ink. In a preferred embodiment the indicator ink is blue and the substrate is white to provide optimal color contrast. An example of a suitable coloring agent for use in the indicator ink is a blue color dye, such as, for example Spectrasol Brilliant Blue GN (Spectra Colors Corporation, Kearny, N.J., USA), or any other dye that allows for good visual contrast between the ink color and the substrate color.

In an exemplary embodiment the composition of the indicator ink has the following components:

Protein

Starch

Binding compound

Ethylenediaminetetraacetic acid (EDTA)

Blue dye (e.g., Spectrasol Brilliant Blue GN)

In other exemplary embodiments the indicator ink may be made to simulate the surface of a product intended for cleaning, and thus may include components that simulate contamination of the product that typically result from an industrial manufacturing process of that product. In such embodiments, the ink composition may include particles and grease, along with one or more of the components identified above.

In an exemplary embodiment the composition of the indicator ink has the following components:

Graphite

Metal dust

Binding compound

Blue dye (e.g., Spectrasol Brilliant Blue GN)

The substrate material may be synthetic paper, plastic, metal, metal alloy (e.g., aluminum alloy), glass, or any other suitable material that is insoluble in water. Specific examples of such materials include Revlar® (RELYCO, Dover, N.H., USA) and Tyvek® (DuPont, Wilmington, Del., USA). FIG. 3. shows an example of an actual test sheet with a Revlar® paper substrate. FIG. 6. shows an example of an actual test sheet with a Tyvek® substrate. The substrate material may have different thicknesses depending on the material nature and composition of the indicator ink. For example, a Revlar® paper substrate can be 0.07 mm to 0.1 mm in thickness, and a Tyvek® substrate can be 0.15 mm to 0.20 mm in thickness. The test sheet may be made available in various sizes to accommodate different ultrasonic machine tank sizes. Alternatively, larger sheets can be cut into smaller ones to fit to smaller size tanks.

In use, the test sheet 100 is preferably placed within the ultrasonic cleaning machine tank at a position that is spaced from the bottom of the tank. The spacing from the bottom may be in the range of 1/16 inch to 2 inches depending on the liquid composition, power and frequency of the ultrasonic transducers, temperature of the liquid, and presence of soluble or particulate components in the tank liquid. The testing procedure may involve operating the ultrasonic cleaning machine for a predetermined period of time, such as, for example, time periods within a range of 3 seconds to 20 minutes, depending on factors such as, for example, the sensitivity of the test sheet to cavitation, the ultrasonic frequency of the machine, the strength of cavitation and the distance of the test sheet from the transducers.

As shown in FIG. 8, in an exemplary embodiment of the invention, the indicator test sheet may be placed underneath a basket as conventionally used in ultrasonic cleaning machines. The test sheet in this embodiment is preferably placed at a distance from the tank bottom, for example, at a distance of approximately ½ inch from the tank bottom.

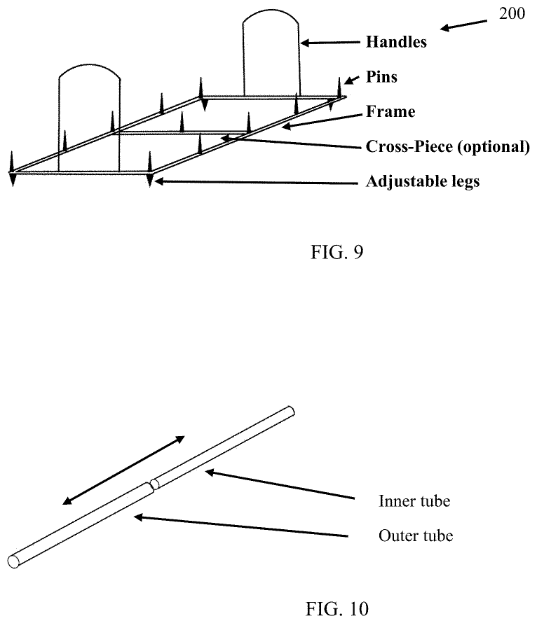

In another exemplary embodiment of the invention the test sheet may be used with a metal or plastic frame that maintains the indicator test sheet at a desirable distance from the tank bottom. FIG. 9 shows a frame, generally designated by reference number 200, according to an exemplary embodiment of the present invention. The frame 200 may be made up of a main frame member that includes one or more handles that allow a user to grasp the main frame member for insertion into and removal from the tank of an ultrasonic cleaning machine tank. The frame 200 may include fastening components for securing the test sheet in position. Although the fastening components are shown as pins in FIG. 9, it should be appreciated that the fastening components may be any other type of structure that allows for securement of the test sheet, such as, for example, clips, pins, or water insoluble adhesive. In exemplary embodiments, the frame 200 may be made available in various sizes to accommodate different sized test sheets and/or ultrasonic cleaning machines. The frame 200 may be adjustable in size and/or shape also to accommodate different sized and/or different shaped test sheets and/or ultrasonic cleaning machines. In this regard, at least a portion of the main frame member and/or other components of the frame 200 may be made up of sub-components that are adjustable in size. For example, as shown in FIG. 10, such sub-components may be telescoping tubing that allows a user to easily adjust the size and/or shape of the frame 200 by sliding the tubes relative to one another.

In an exemplary embodiment, the frame 200 may include adjustable legs that provide the desirable distance of the test sheet from the bottom. The frame 200 may further include a cross-piece or some other structural component at or near the middle portion of the frame 200 to support the test sheet.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

1. A method of testing operation of an ultrasonic cleaning machine, comprising:
providing a test sheet comprising a substrate and an ink composition disposed on the substrate;
disposing the test sheet within the ultrasonic cleaning machine so that the test sheet is positioned in facing relation to ultrasonic transducers of the ultrasonic cleaning machine; and
operating the ultrasonic cleaning machine so that visually discernable regions are formed at locations on the test sheet that correspond to operational ones of the ultrasonic transducers.

2. The method of claim 1, wherein a color of the ink composition is different from a color of the substrate.

3. The method of claim 2, wherein the visually discernable regions result from at least partial removal of the ink composition from the substrate.

4. The method of claim 3, wherein the ink composition is blue and the substrate is white.

5. The method of claim 1, wherein the visually discernable regions result from degradation of the ink composition.

6. The method of claim 1, wherein the visually discernable regions result from change of color of the ink composition.

7. The method of claim 1, wherein the ultrasonic cleaning machine is operated for a time of 3 seconds to 20 minutes.

8. The method of claim 1, wherein the ink composition is water insoluble.

9. The method of claim 1, wherein the test sheet is disposed within the ultrasonic cleaning machine at a location spaced at a distance from a bottom of a tank of the ultrasonic cleaning machine.

10. The method of claim 9, wherein the distance is 1/16 inch to 2 inches.

11. The method of claim 1, wherein the test sheet is sized so as to be in direct facing relation to all transducers of the ultrasonic cleaning machine.

12. The method of claim 1, wherein the substrate is made of plastic, synthetic paper, glass or metal.

13. The method of claim 1, wherein the substrate is made of flashspun high-density polyethylene fibers.

14. The method of claim 1, wherein the ink composition comprises at least one of proteins, lipids, polysaccharides or combinations thereof, and stabilizers.

15. The method of claim 1, wherein the ink composition comprises at least one of graphite, metal, oils or combinations thereof, and stabilizers.

16. The method of claim 1, wherein the step of disposing comprises placing the test sheet below a basket of the ultrasonic cleaning machine.

17. The method of claim 1, wherein the step of disposing comprises placing the test sheet within a frame and disposing the frame within the ultrasonic cleaning machine.

18. The method of claim 17, wherein the frame is adjustable in at least one of size or shape.

19. The method of claim 17, wherein the frame comprises fastening components that hold the test sheet in the frame.

20. The method of claim 19, wherein the fastening components comprise pins, clips or adhesive.

21. A system for testing operation of an ultrasonic cleaning machine, the system comprising:
a test sheet comprising:
a substrate; and
an ink composition disposed on the substrate,
the test sheet being configured for placement in the ultrasonic cleaning machine in facing relation to ultrasonic transducers of the ultrasonic cleaning machine so that operating the ultrasonic cleaning machine results in formation of visually discernable regions at locations on the test sheet that correspond to operational ones of the ultrasonic transducers.

22. The system of claim 21, wherein a color of the ink composition is different from a color of the substrate.

23. The system of claim 21, wherein the visually discernable regions result from at least partial removal of the ink composition from the substrate.

24. The system of claim 23, wherein the ink composition is blue and the substrate is white.

25. The system of claim 21, wherein the visually discernable regions result from degradation of the ink composition.

26. The system of claim 21, wherein the visually discernable regions result from change of color of the ink composition.

27. The system of claim 21, wherein the ink composition is water insoluble.

28. The system of claim 21, wherein the test sheet is sized so as to be in direct facing relation to all transducers of the ultrasonic cleaning machine.

29. The system of claim 21, wherein the substrate is made of plastic, synthetic paper, glass or metal.

30. The system of claim 21, wherein the substrate is made of flashspun high-density polyethylene fibers.

31. The system of claim 21, wherein the ink composition comprises at least one of proteins, lipids, polysaccharides or combinations thereof, and stabilizers.

32. The system of claim 21, wherein the ink composition comprises at least one of graphite, metal, oils or combinations thereof, and stabilizers.

33. The system of claim 21, wherein the test sheet is configured for placement below a basket of the ultrasonic cleaning machine.

34. The system of claim 21, further comprising a frame that holds the test sheet in position within the ultrasonic cleaning machine.

35. The system of claim 34, wherein the frame is adjustable in at least one of size or shape.

36. The system of claim 34, wherein the frame comprises fastening components that hold the test sheet in the frame.

37. The system of claim 36, wherein the fastening components comprise pins, clips or adhesive.
